(19) United States
(12) Patent Application Publication
(10) Pub. No.: US 2009/0260122 A1
(43) Pub. Date: Oct. 22, 2009

(54) Super absorbent polymer gel and products thereof

(76) Inventors: Chin-Chu Chang, Nantou (TW); Nai-Sung Wen, Changhua (TW); Chin-Shu Wen, Changhua (TW)

Correspondence Address: SAM CHEN, 7F-1, 293, ROOSEVELT ROAD, SEC 3, TAIPEI, TW

(21) Appl. No.: 12/105,261

(22) Filed: Apr. 17, 2008

(51) Int. Cl. A62B 17/04; A62D 1/00; E05G 1/00; D04H 13/00

(52) U.S. Cl. 2/7; 252/2; 442/327; 2/12; 2/16; 220/560.01

(57) ABSTRACT

A layer structure for insulating thermal source includes a gel layer having two opposite faces each sequentially having an absorbent layer and a non woven material layer applied thereon. The layer structure is crisscross stitched such that multiple stitch lines are crisscross formed on the outer periphery of the layer structure for enhancing the layer structure. The absorbent layer is made of super absorbent polymer (SAP). The SAP is white or primrose neutral particle without toxicity and smell. The absorbent principle of the SAP is different from that of the foam rubber, the absorbent cotton or the like. The absorbent ability of the SAP is related to a chemical reaction such that the SAP is hard to be dehydrated due to an external force when the SAP absorbs water and forms an expanded gel.

### BACKGROUND OF THE INVENTION

1. Field of the Invention

The present invention relates to a fireproof material and the products thereof, and more particularly to a super absorbent polymer gel and the products thereof.

2. Description of Related Art

Persons always are besieged and can not escape from a fire accident due to high temperature, roaring flame and dense smoke when a fire accident is occurred. Consequently, how to quickly separate, extinguish the roaring flame or help the besieged people escaping from the fire accident is the only way for reducing damage. Base on extinguish the roaring flame, water, dry powder, carbon dioxide or chemical foam is often used to separate the roaring flame from atmosphere or reduce the temperature for extinguish the roaring flame. However, these above extinguish material can not provide an effective extinguish purpose when the roaring flame extends to a great area, such as a burned house or a burned forest because the water is vaporized due to a high temperature and the carbon dioxide will be scattered and disappeared. In addition, the chemical foam may pollute the natural environment.

As regard to a fireproof coating, the fireproof coating is made of fireproof material such that the fireproof coating is expensive and has a short using life. As a result, the fireproof coating can not be provided for an emergency. In addition, the effect of a heat insulation of the conventional fireproof coating is weak such that the user may feel a very hot such as scorching in the scene of a fire and can not escape from the scene of a fire or wait for a rescue in an area where is not yet flamed.

In other words, it is important to provide an improved fireproof coating that has a high heat insulation and is easy worn for user to escape from the place where in flamed or protect the user from a high temperature and wait for a rescue in an area where is not yet flamed. As a result, the number of the casualties should be greatly reduced.

The present invention has arisen to mitigate and/or obviate the disadvantages of the conventional fireproof material and the product thereof.

### SUMMARY OF THE INVENTION

The main objective of the present invention is to provide an improved polymer gel for insulating thermal source. To achieve the objective, the polymer gel in accordance with the present invention uses super absorbent polymer (SAP) as its most important material, the SAP forming an SAP gel when combined with water, the SAP gel laid over a roaring flame for extinguishing or an object in a scene of a fire for protection.

A secondary objective of the present invention is to provide a layer structure that is made of the polymer gel as above. The layer structure is provided to lay over roaring flame for extinguishing the roaring flame. To achieve the objective, the layer structure for insulating thermal source in accordance with the present invention includes a gel layer having two opposite faces each sequentially having an absorbent layer and a non woven material layer applied thereon. The layer structure is crisscross stitched such that multiple stitch lines is crisscross formed on the outer periphery of the layer structure for enhancing the composition of the layer structure.

A further objective of the present invention is to provide a fireproof coating that is made of the layer structure as above. To achieve the objective, the fireproof coating in accordance with the present invention is formed with a cap-like cover for protecting user's head and the cap-like cover has a first connecting unit formed an a distal edge thereof. In the preferred embodiment of the present invention, the first connecting unit is a structure of hook and loop. A mask and an eyeshade are respectively connected to the first connecting unit for filtering dense smoke and protecting user's eyes. The mask and the eyeshade are connected to each other. A second connecting unit is formed on two cuffs of the fireproof coating for connecting with a pair of gloves. The pair of gloves can protect user's hand to push the exit and the obstacles when escaping from the scene of a fire.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a layer structure that is made of super absorbent polymer gel in accordance with the present invention;

FIG. 2 is a cross-sectional view of the layer structure in FIG. 1;

FIG. 3 is a front plan view of a fireproof coating that is made of the layer structure in FIG. 1;

FIG. 4 is a schematic view of the fireproof coating in FIG. 3;

FIG. 5 is a perspective view of a bag that is provided to contain the layer structure or the fireproof coating in accordance with the present invention, and the water.

FIG. 6 is an operational view of the bag, in FIG. 5, which contains water in one side of the bag.

FIG. 7 is an operational flow chart of the bag in FIG. 5 for showing the contained water flow to the fireproof coating that is stored in the bag in accordance with the present invention.

### DETAILED DESCRIPTION OF THE INVENTION

A super absorbent polymer (SAP) is a high polymer material that has an excellent absorbency, an ability of containing water, no toxicity and can be automatically decomposed. The SAP has an excellent stability when containing water. The SAP would not become black and change the ability of containing water when being heated to a temperature of 150° C. The SAP can be stored in an airtight container for a long time without changing its property of excellent absorbency. The SAP can absorb the water which has a weight thousands times the weight of the SAP. The SAP has various types and different technical arts with its own materials. In general, the SAP is selected from the group consisting of polyacrylate, polyvinyl alcohol, ethylene vinyl acetate, polyurethane, polyethylene oxide and starch grafting copolymer. In addition, some selected SAP may be combined with rubber to form a composite absorbent material.

The SAP is white or primrose neutral particle without toxicity and smell. The absorbent principle of the SAP is different from that of the foam rubber, the absorbent cotton or the like. The absorbent ability of the SAP is related to a chemical reaction such that the SAP is hard to be dehydrated due to an external force when the SAP absorbs water and forms an expanded gel.

The present invention uses the SAP gel to insulate thermal source and form a layer structure such that the SAP is the most important material of the present invention. The SAP in accordance with the present invention is selected from the group consisting of polyacrylate, polyvinyl alcohol, ethylene vinyl acetate, polyurethane, polyethylene oxide and starch grafting copolymer. In addition, some selected SAP is combined with rubber to form a composite absorbent material.

Based on the purpose, the SAP powder is stored in a container that is connected to a fire fighting watergun. The SAP powder will flow into the water when the fire fighting watergun jets water to the roaring flame. In addition, the SAP powder can be previously mixed with the water in the tank of the fire brigade wagon. The SAP powder quickly absorbs and contains water to form a gel for laying over the roaring flame or the objects for insulating the objects from the roaring flame.

The SAP gel has excellent water-holding capacity and weather-resistant capacity such that the SAP gel can reduce the transmission of the heat. As a result, the SAP gel can insulate the roaring flame from the atmosphere such that the roaring flame loses the condition of burning when the SAP gel is laid over the roaring flame. In addition, the SAP gel absorbs the heat energy from the roaring flame and the roaring flame is extinguished when the temperature is reduced under the flash point of the burned objects. Some water based adhesive is added into the SAP gel to enhance the stickiness of the SAP gel such that the improved SAP gel can completely lay over the burned objects for promoting the fireproof effect of the SAP gel.

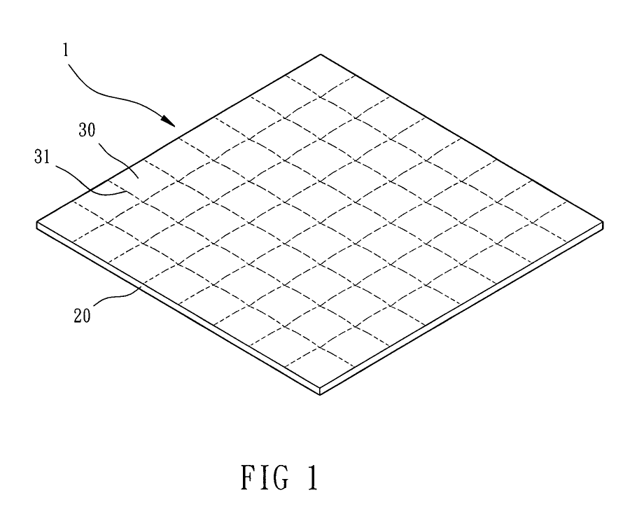

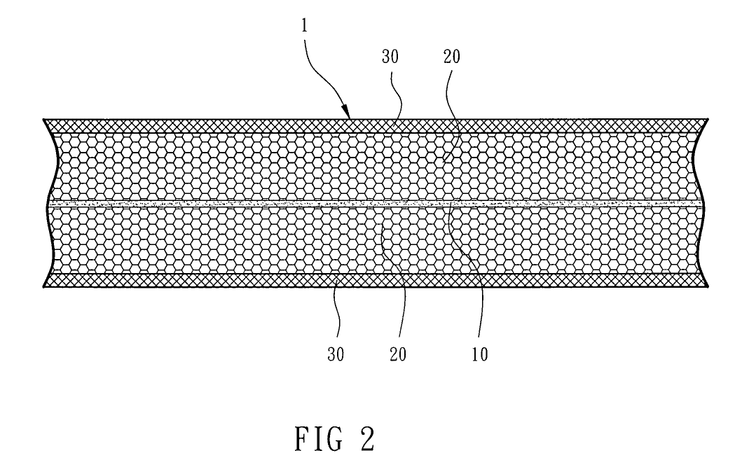

With reference to FIGS. 1 and 2, the SAP gel in accordance with the present invention is used to a layer structure (1). The layer structure (1) includes a gel layer (10) formed with two opposite faces. Each face of the gel layer has an absorbent layer (20) covered thereon. Each absorbent layer (20) is made from the SAP powder that can form SAP gel with water, and has a non woven material layer (30) covered thereon. The non woven material layer (30) is made from 100% viscose fiber or 35% viscose fiber combined with 65% polyester. The layer structure (1) is crisscross stitched such that multiple stitch lines (31) is crisscross formed on the outer periphery of the layer structure (1) for preventing the SAP powder/SAP gel from arbitrarily flowing or gathering up.

In use, the structure (1) in accordance with the present invention is provided to lay over the roaring flame or the objects in the burned place and spray with water that will held in the absorbent layer (20) to insulate the roaring flame from the atmosphere such that the roaring flame loses the condition of burning. In addition, the absorbent layer (20) absorbs the heat energy from the roaring flame and the roaring flame is extinguished when the temperature is reduced under the flash point of the burned objects.

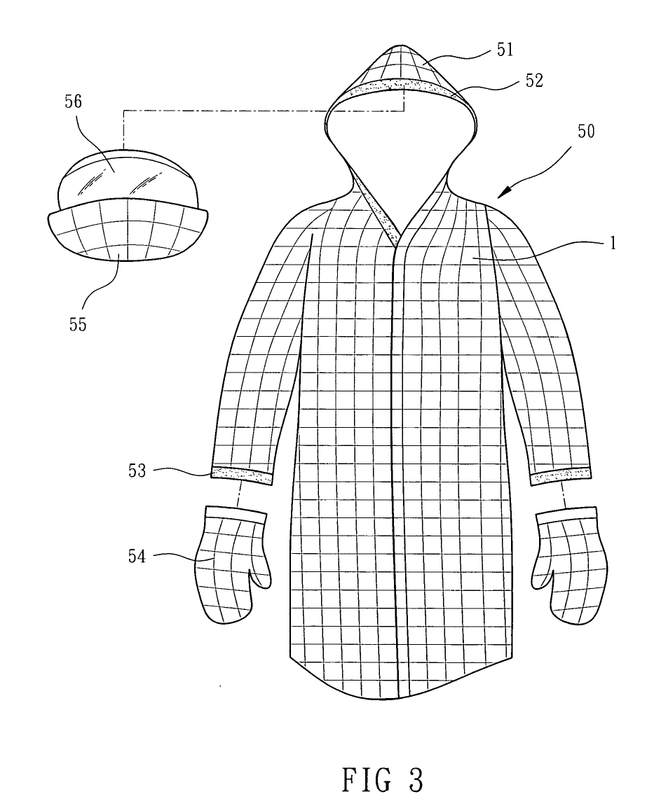

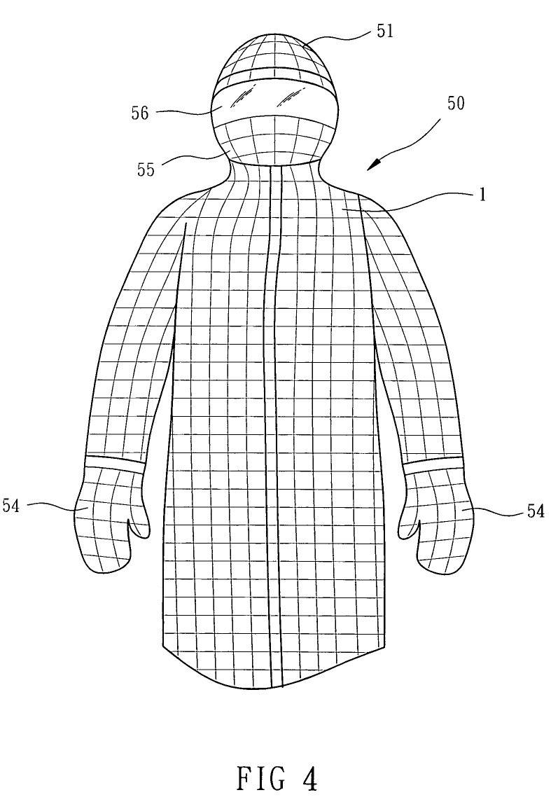

With reference to FIGS. 3 and 4 show a fireproof coating (50) that is made of the layer structure (1) in accordance with the present invention, the fireproof coating (50) is formed with a cap-like cover (51) for protecting user's head and the cap-like cover (51) has a first connecting unit (52) formed an a distal edge thereof. In the preferred embodiment of the present invention, the first connecting unit (52) is a structure of hook and loop. A mask (55) and an eyeshade (56) are respectively connected to the first connecting unit (52) for filtering dense smoke and protecting user's eyes. The mask (55) and the eyeshade (56) are connected to each other. A second connecting unit (53) is formed on two cuffs of the fireproof coating (50) for connecting with a pair of gloves (54). The pair of gloves (45) can protect user's hand to push the exit and the obstacles when escaping from the scene of a fire.

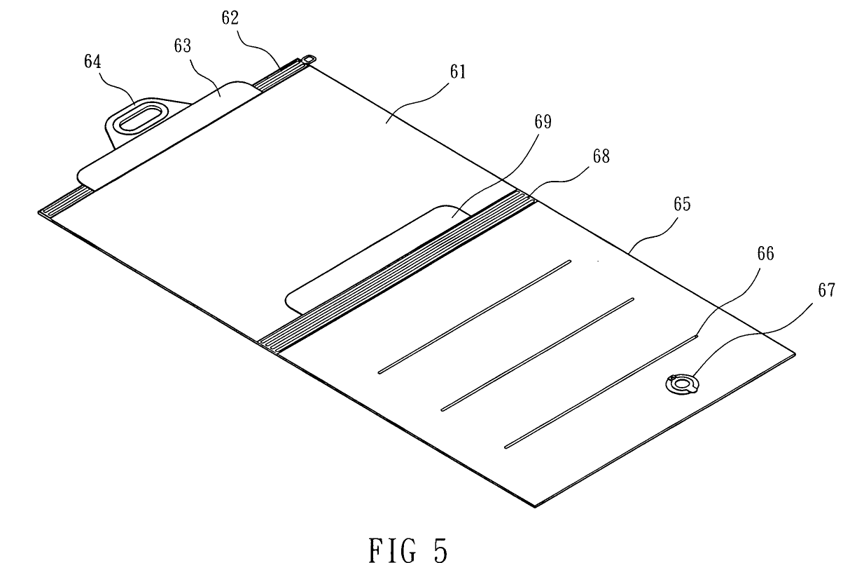

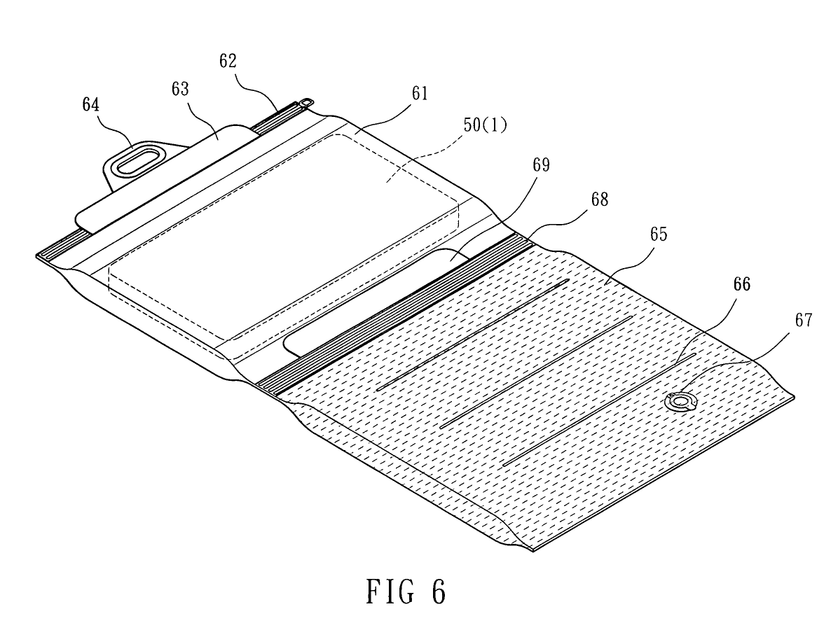

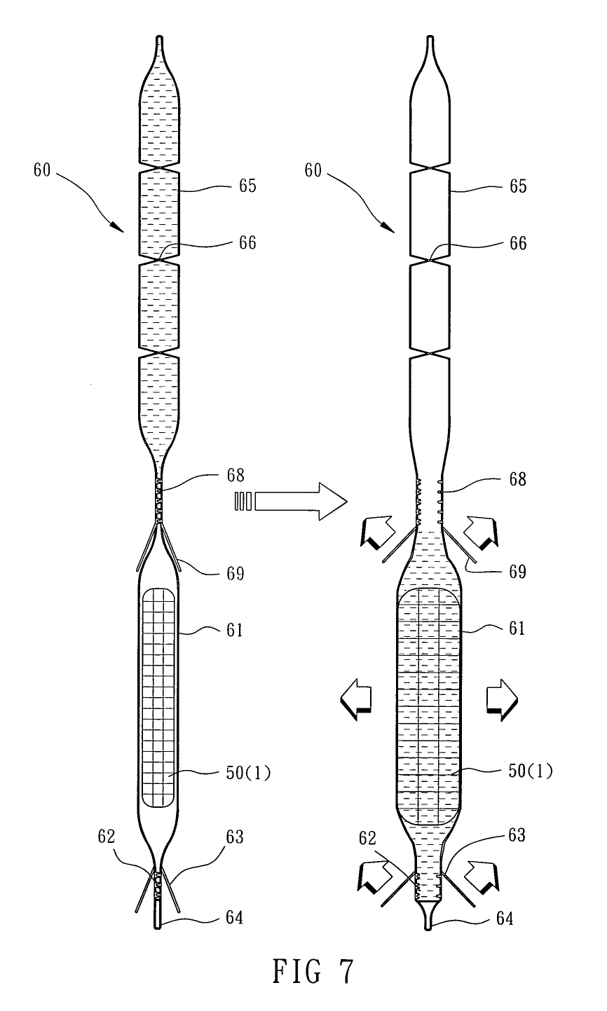

With reference to FIGS. 5 and 6, a bag (60) is provided to keep the layer structure (1) or the fireproof coating (50) as described above. A first receiving space (61) and a second receiving space (65) are respectively defined in to opposite ends of the bag (60). The first receiving space (61) and the second receiving space (65) selectively communicate with each other. The first receiving space (61) is provided to keep the layer structure (1)/the fireproof coating (50) and the second receiving space (65) is provided to contain water. A closing element (62) disposed on one side of the first receiving space (61) opposite to the second receiving space (65) for selectively closing the first receiving space (61). In the preferred embodiment of the present invention, the closing element (62) is a zipper strip. The closing element (62) has two opposite sides each having a first puller (63) disposed thereon for user to quickly open the first receiving space (61). One side of the first receiving space (61) has a handle (64) disposed thereon for user to easily carry the bag (60) with the layer structure (1)/fireproof coating (50) and water. Multiple partitions (66) are securely disposed in the second receiving space to prevent the water in the second receiving space from being overly gathered. An inlet nozzle (67) is mounted on an outer periphery of the second receiving space (65) for user to input water into the second receiving space (56). A lateral airtight element (68) is disposed in the bag (60) for selectively separating the first receiving space (61) from the second receiving space (65). In the preferred embodiment of the present invention, the lateral airtight element (68) includes multiple parallel zipper strips. The airtight element (68) has two opposite sides each having a second puller (69) connected thereon for user to easily and quickly open the airtight element (68), as shown in FIG. 7. The water in the second receiving space (65) flows into the first receiving space (61) such that the SAP powder in the layer structure (1) or the fireproof coating (50) will absorb the water to form SAP gel for extinguishing the roaring flame or emergent escape.

Although the invention has been explained in relation to its preferred embodiment, it is to be understood that many other possible modifications and variations can be made without departing from the spirit and scope of the invention as hereinafter claimed.

What is claimed is:

1. A super absorbent polymer (SAP) gel comprising an SAP adapted to mix with water to extinguish a fire.

2. The SAP gel as claimed in claim 1, wherein the SAP is selected from a group consisting of polyacrylate, polyvinyl alcohol, ethylene vinyl acetate, polyurethane, and polyethylene oxide, and the SAP is adapted to mix with rubber to form a composite absorbent material.

3. The SAP gel as claimed in claim 1, wherein a water based adhesive is added into the SAP gel to increase stickiness.

4. The SAP gel as claimed in claim 3, wherein the water based adhesive is polyvinyl alcohol.

5. A layer structure for insulating thermal source comprising at least one absorbent layer made of SAP powder that absorbs water and forms an SAP gel, the absorbent layer having two opposite faces each having a non woven material layer laid over an outer periphery of the absorbent layer.

6. The layer structure as claimed in claim 5 further comprising at least one gel layer having two opposite faces each having an absorbent layer laid over an outer periphery of the gel layer.

7. The layer structure as claimed in claim 5, wherein the non woven material layer is adapted to be naturally decomposed.

8. The layer structure as claimed in claim 5, the non woven material layer is made from 35% viscose fiber combined with 65% polyester.

9. The layer structure as claimed in claim 5, wherein the non woven material layer is made from 100% viscose fiber.

10. The layer structure as claimed in claim 5, wherein the layer structure is crisscross stitched such that a plurality of stitch lines are crisscross formed on the outer periphery of the layer structure for supporting the layer structure.

11. The layer structure as claimed in claim 5, wherein the layer structure is sewed to form a fireproof coating.

12. The layer structure as claimed in claim 11, wherein the fireproof coating is formed with a cap-like cover for protecting user's head, and further comprising a mask and an eyeshade respectively connected to the cap-like cover for filtering dense smoke and protecting user's eyes.

13. The layer structure as claimed in claim 11, wherein the fireproof coating has a pair of gloves respectively connected to two cuffs of the fireproof coating, the pair of gloves being made of the layer structure for protecting user's hand.

14. A bag comprising a first receiving space and a second receiving space respectively defined in two opposite ends of the bag, the first receiving space provided to receive a layer structure or a fireproof coating that is made of SAP gel, and the second receiving space provided to contain water, and an airtight element disposed between the first receiving space and the second receiving space for selectively and airtightly separating the first receiving space from the second receiving space such that the water is adapted to flow into the first receiving space when the airtight element is opened.

15. The bag as claimed in claim 14 further comprising a closing element disposed on one side of the first receiving space opposite to the second receiving space for selectively closing the first receiving space.

16. The bag as claimed in claim 15, wherein the closing element has two opposite sides each having a first puller disposed thereon for user to quickly open the first receiving space.

17. The bag as claimed in claim 14 further comprising a plurality of partitions securely disposed in the second receiving space.

18. The bag as claimed in claim 14 further comprising an inlet nozzle mounted on an outer periphery of the second receiving space for user to pour water into the second receiving space.

19. The bag as claimed in claim 14, wherein the airtight element includes a plurality of parallel zipper strips.

20. The bag as claimed in claim 14, wherein the airtight element has two opposite sides each having a second puller connected thereon for user to easily and quickly open the airtight element.
